(19) United States
(12) Patent Application Publication
(10) Pub. No.: US 2008/0138181 A1
(43) Pub. Date: Jun. 12, 2008

(54) THERMALLY CONDUCTIVE PUMP MOTOR MOUNT FOR LIFTGATE SYSTEM

(76) Inventors: Dane W. Gregg, (US); Charles Wilson, North Canton, OH (US)

Correspondence Address: BROUSE MCDOWELL LPA, 388 SOUTH MAIN STREET, SUITE 500, AKRON, OH, 44311, US

(21) Appl. No.: 11/855,548

(22) Filed: Sep. 14, 2007

Related U.S. Application Data
(60) Provisional application No. 60/825,942, filed on Sep. 18, 2006.

(51) Int. Cl. H02K 9/00; B60P 9/00

(52) U.S. Cl. 414/462; 310/64; 415/177

(57) ABSTRACT

A conductive heat transfer system may include a heat conductive element to thermally couple the pump motor of a liftgate assembly to an outer surface of a pump motor housing assembly.

This application claims priority from U.S. provisional patent application Ser. No. 60/825,942 titled THERMALLY CONDUCTIVE PUMP MOTOR MOUNT FOR LIFTGATE SYSTEM filed on Sep. 18, 2006, which is incorporated herein by reference.

### I. BACKGROUND OF THE INVENTION

A. Field of Invention

This invention pertains to the art of methods and apparatuses regarding liftgates and more specifically to methods and apparatuses regarding the transfer of heat away from liftgate heat generating components such as pump motors.

B. Description of the Related Art

It is well known in the art to attach liftgates to vehicle trailers or other forms of vehicle cargo holds to assist with loading and unloading of the vehicles. In general, liftgates include a platform or deck and an adjustment system used to move the platform. To load cargo from a ground surface to the vehicle bed, the platform is positioned in a lowered position where it is generally parallel with the ground surface. The cargo can then be easily placed onto the platform. The platform is then lifted to a raised position generally parallel with the vehicle bed. The cargo can then be easily loaded into the vehicle. To unload cargo from the vehicle, the reverse steps are taken.

Various types and styles of liftgates are known in the art. Some non-limiting examples include conventional liftgates, flip-a-way or fold-up liftgates, rail type liftgates, and special purpose liftgates. Often the adjustment system includes a hydraulic system. Hydraulic systems generally work well for their intended purpose. They are know to have a heat transfer problem, however.

FIG. 1 shows a portion of a known liftgate assembly. More specifically, the major components of a liftgate adjustment system 1 are illustrated. The adjustment system 1 includes a pair of hydraulic cylinders 2 used to adjust the position of a liftgate platform (not shown) in a known manner. A hydraulic pump and motor unit 3 is used to provide hydraulic fluid to control valves 4 and then to the cylinders 2. Piping, hoses and fittings 5 hydraulically connect these components together. Control wiring 6 connects a control system (not shown) to the pump and motor unit 3 and power wiring 7 connects a power supply (not shown) to the pump and motor unit 3. The pump and motor unit 3 is received within a housing assembly 10. The housing assembly 10 shown includes a slide tray 11 that is received within a housing shell 12. A cover plate 13, which may be positioned at any location on the housing shell 12 or the slide tray on 11, is provided to provide access into the housing assembly 10.

With continuing reference to FIG. 1, liftgate housing assemblies, such as the housing assembly 10 illustrated, are required to protect selected liftgate components, such as the pump and motor unit 3, as shown. Selected liftgate components require protection from road damage, road debris, salt spray and other corrosive materials, for a few non-limiting examples. Thus, liftgate housings are typically enclosed, as is the housing assembly 10. Many liftgate components, however, create heat. The resultant problem is that heat transfer from the selected liftgate components, which is required to maintain the liftgate components in ideal working conditions, is difficult within such a stagnant environment. Undesirable heat thus builds up within the housing and the pump motor may overheat causing motor melt down or motor failure. Another potential problem is that an auxiliary device such as a thermal switch or thermal couple may sense the over temperature and shut the motor down. Without a functional pump motor, the liftgate adjustment system will not operate and, as a result, the liftgate assembly is rendered inoperative. An inoperative liftgate assembly reduces the efficiencies of the liftgate assembly, the corresponding vehicle, and the corresponding operators.

It should be noted that conventional methods for improving heat transfer are not available. Reducing the degree of housing enclosure, for example, will not work for the reasons noted above. Another known method is to use an air moving device, such as a fan for convection. This method is also impractical because sufficient air flow out of the enclosed housing to the outside environment is not possible.

The present invention provides methods and apparatuses for improving the transfer of heat away from the enclosed housing required for liftgate assemblies. This invention thus overcomes the foregoing difficulties and others while providing better and more advantageous overall results.

### II. SUMMARY OF THE INVENTION

According to one embodiment of this invention, a liftgate assembly may comprise: a mount assembly for use in mounting the liftgate assembly to an associated vehicle; a platform assembly including a platform having a traffic surface for use in receiving traffic for loading and unloading cargo; a lift arm assembly that interconnects the platform assembly to the mount assembly; an adjustment system for use in moving the platform between a lowered position and a raised position, the adjustment system comprising: (a) at least one hydraulic cylinder; (b) a housing assembly; (c) a hydraulic pump and pump motor unit used to provide hydraulic fluid to the hydraulic cylinder, wherein the pump motor is positioned within the housing assembly; and, (d) a conductive heat transfer system that thermally couples the pump motor to the housing assembly for conductive heat transfer.

According to another embodiment of this invention, the conductive heat transfer system may comprise: a first layer of material comprising: (1) a first side having a first surface that physically contacts the outer surface of the pump motor, the first surface having a shape that substantially matches the shape of the outer surface of the pump motor; and, (2) a second side having a second surface that physically contacts a surface of the housing assembly, the second surface having a shape that substantially matches the shape of the surface of the housing assembly.

According to another embodiment of this invention, the conductive heat transfer system may further comprise: a second layer of heat conductive material.

According to another embodiment of this invention, a securing mechanism may be used to secure the heat conductive element into contact with the corresponding surfaces.

According to still another embodiment of this invention, a method may comprise the steps of:

(A) providing a liftgate assembly comprising: a mount assembly for use in mounting the liftgate assembly to an associated vehicle; a platform assembly including a platform having a traffic surface for use in receiving traffic for loading and unloading cargo; a lift arm assembly that interconnects the platform assembly to the mount assembly; an adjustment system for use in moving the platform between a lowered position and a raised position, the adjustment system comprising: (a) at least one hydraulic cylinder; (b) a housing assembly; and, (c) a hydraulic pump and pump motor unit used to provide hydraulic fluid to the first hydraulic cylinder;

(B) providing a first layer of conductive heat transfer material having: (a) a first side with a first surface having a shape that substantially matches the shape of the outer surface of the pump motor; and, (b) a second side with a second surface having a shape that substantially matches the shape of a surface of the housing assembly; and,

(C) placing the hydraulic pump and pump motor unit and the first layer of conductive heat transfer material within the housing assembly such that the first side contacts the outer surface of the pump motor and the second side contacts the surface of the housing assembly to thereby thermally couple the pump motor to the housing assembly for conductive heat transfer.

One advantage of this invention is that, liftgate cycles prior to thermal shutdown are maximized. Liftgate down time is thus minimized.

Another advantage of this invention is that motor damage is minimized.

Still another advantage of this invention is that excess current draw from batteries due to lower efficiency of motors at high temperatures is minimized.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is an assembly view of a prior art adjustment system for a liftgate assembly illustrating an enclosed housing.

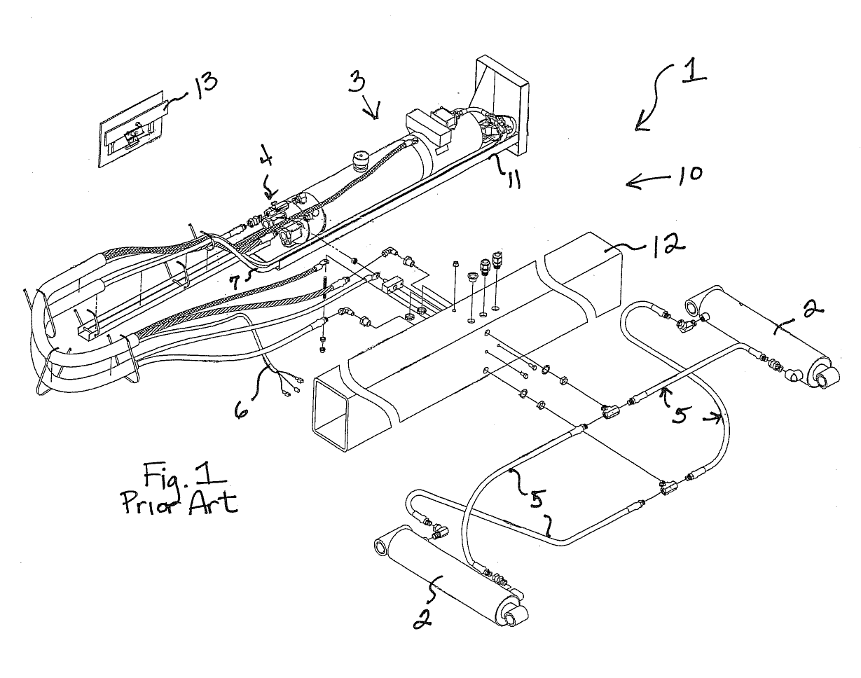

FIG. 2 is a perspective view of a liftgate assembly.

FIG. 3 is a perspective assembly drawing illustrating how the invention may be used.

### IV. DETAILED DESCRIPTION OF THE INVENTION

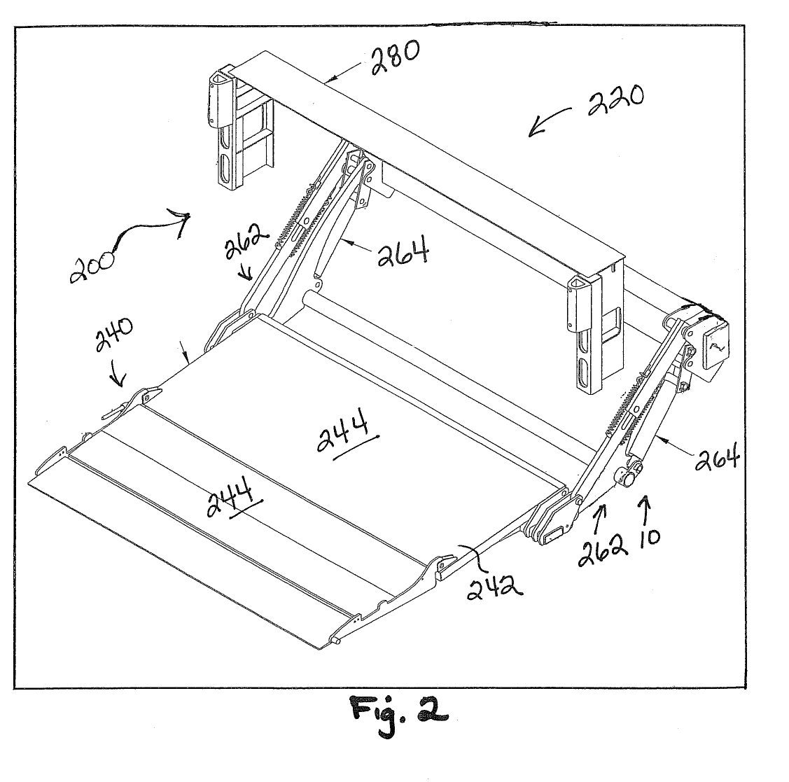

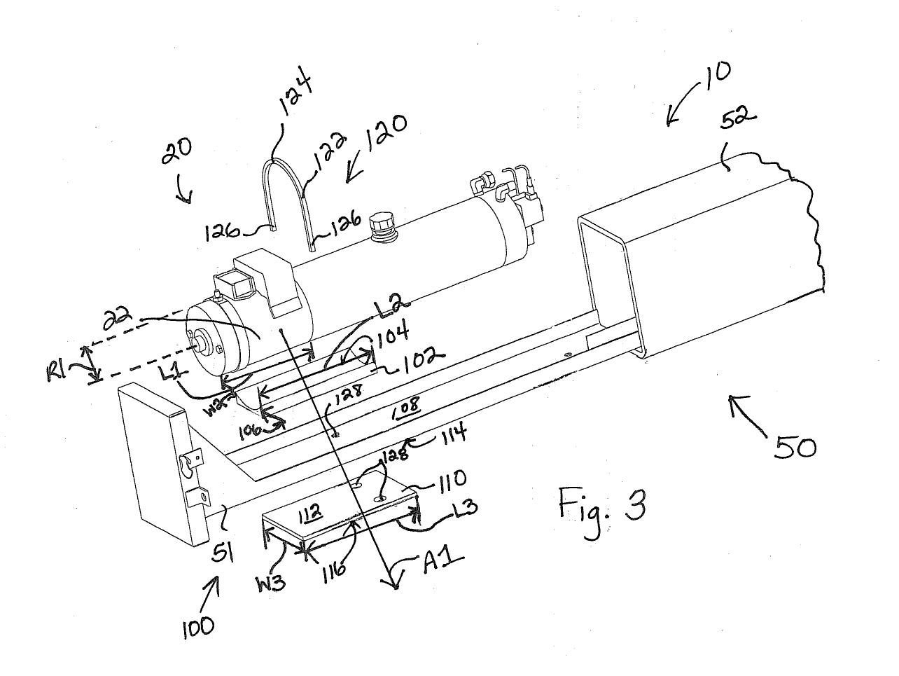

Referring now to the drawings wherein the showings are for purposes of illustrating embodiments of the invention only and not for purposes of limiting the same, FIG. 2 shows a liftgate assembly 200 that may use a conductive heat transfer system 100 (shown in FIG. 3) according to this invention. The liftgate assembly 200 may have a mount assembly 220 four use in mounting the liftgate assembly 200 to a vehicle (not shown) in any known manner and may include a bed extension 280. The liftgate assembly 200 may also have a platform assembly 240 including a platform or deck 242. The platform or deck 242 may include one or more generally planar sheet or plate members each having a traffic surface 244 adapted to receive traffic for loading and unloading cargo. A lift aim assembly 262 interconnects the platform assembly 242 to the mount assembly 220 and may permit relative motion of the platform 242 as will be described further below. While the liftgate assembly 200 shown is the style known as flip-a-way or fold-up, it is to be noted that this invention will work with any liftgate style, type and size, when applied with sound engineering judgment.

With reference now to FIGS. 2 and 3, the liftgate assembly 200 may also include an adjustment system 10 which is used to move the platform 242 between a lowered position (shown in FIG. 2) a raised position (not shown but well known in the art) and, in one embodiment, a folded or storage position (also not shown but well known in the art). The adjustment system 10 may include a pair of hydraulic cylinders 264 and the conductive heat transfer system 100. The adjustment system 10 may also include a hydraulic pump and motor unit 20 used to provide hydraulic fluid to the cylinders 264 in any known manner. Various other liftgate components, including control valves, hydraulic piping and hoses, control wiring and power wiring are not shown for clarity but can be used in any manner applied with sound engineering judgment. The pump and motor unit 20 is received within a housing assembly 50. The housing assembly 50 may be positioned for use in any known location such as on the vehicle. The housing assembly 50 shown includes a slide tray 51 that is received within a housing shell 52. However, the conductive heat transfer system 100 of this invention will work well with any type of liftgate housing assembly chosen with sound engineering judgment. Once the pump and motor unit 20 is mounted to the slide tray 51, the slide tray 51 is slid within the housing shell 52 to provide a substantially enclosed environment. An enclosed housing is required for a liftgate assembly for the reasons explained above.

With reference now to FIG. 3, the conductive heat transfer system 100 may include at least one heat conductive element to thermally couple the pump motor 22 to an outer surface of the housing assembly 50. By “heat conductive element” it is meant a layer of material adapted to conductively transfer heat. For the embodiment shown, a first heat conductive element 102 has a first surface 104 adapted to contact the pump motor 22 and a second surface 106 adapted to contact an inner surface 108 of the tray 51. A second heat conductive element 110 has a first surface 112 adapted to contact an outer surface 114 of the tray 51 and a second surface 116 adapted to contact an inner surface of the housing shell 52. Heat from the motor 22 can thus be easily conducted in direction A1 through the first conductive element 102, then through the tray 51, then through the second conductive element 110 and finally through the housing shell 52. The conductive heat transfer system 100 may also include a securing mechanism 120 to secure the heat conductive elements into contact with their corresponding surfaces. The securing mechanism 120 shown includes a U-shaped member 122 having a mid-section 124 and a pair of legs 126. The mid-section 124 may be shaped and sized to match the outer surface of the motor 22. The legs 126 may be received in holes 128 formed in other components, as shown. In one embodiment, the legs 126 have threads so that nuts (not shown) may be attached to the legs 126 to hold the components in contact so that conductive heat transfer is maximized.

With continuing reference to FIG. 3, in one embodiment a surface of the heat conductive element is shaped to match the corresponding surface contacted by the heat conductive element. The first surface 104 of the first heat conductive element 102, for example, has a curved shape to match the curved outer surface of the motor 22 while the second surface 106 has a planar shape to match the planar inner surface 108 of the tray 51.

With continuing reference to FIG. 3, as a general rule the amount of conductive heat transferred is increased in direct proportion to the heat transfer surface areas in contact with each other. As a result, this invention works better when the heat transfer surface areas are increased. For the embodiment shown, the pump motor has a length L1 and a radius R1. In one embodiment, the first heat conductive element 102 has a length L2 that is at least as long as the length L1 of the pump motor. In another embodiment, the length L2 is greater than the length L1, as shown. In another embodiment the second heat conductive element 110 has a length L3 that is at least as long as the length L1 of the pump motor. In another embodiment, the length L3 is greater than the length L1, as shown. In yet another embodiment, the length L3 is substantially equal to the length L2. In another embodiment, the first heat conductive element 102 has a width W2 that is at least as wide as the radius R1. In another embodiment, the width W2 is greater than the radius R1, as shown. In another embodiment, the second heat conductive element 110 has a width W3 that is at least as wide as the radius R1. In another embodiment, the width W3 is greater than the radius R1, as shown. In yet another embodiment, the width W2 is substantially equal to the width W3. According to one embodiment, the first surface 104 of the first heat conductive element 102 that contacts the pump motor contacts at least 10% of the outer body surface area of the pump motor. Because the pump motor show in is cylindrically shaped, it has an outer body surface area (not counting the surface area of the ends) SA equal to 2πRL. Thus, the area of the first surface 104 may be 10% of 2πRL. However, this invention will work well with motors having alternate shapes as well. In a more preferred embodiment, the first surface 104 of the first heat conductive element 102 contacts at least 20% of the outer body surface area of the pump motor. In yet a more preferred embodiment, shown in FIG. 3, the first surface 104 contacts at least 30% of the outer body surface area of the pump motor.

Still referring to FIG. 3, the heat conductive elements may be formed of any material chosen with sound engineering judgment to provide sufficient conductive heat transfer. Ideal heat transfer materials include aluminum and copper. Some ideal heat transfer materials, however, may be impractical due to their cost. In one embodiment, a mild steel may be used.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A liftgate assembly comprising:
a mount assembly for use in mounting the liftgate assembly to an associated vehicle;
a platform assembly including a platform having a traffic surface for use in receiving traffic for loading and unloading cargo;
a lift arm assembly that interconnects the platform assembly to the mount assembly;
an adjustment system for use in moving the platform between a lowered position and a raised position, the adjustment system comprising:
(a) at least one hydraulic cylinder;
(b) a housing assembly;
(c) a hydraulic pump and pump motor unit used to provide hydraulic fluid to the hydraulic cylinder, wherein the pump motor is positioned within the housing assembly; and,
(d) a conductive heat transfer system that thermally couples the pump motor to the housing assembly for conductive heat transfer, the conductive heat transfer system comprising: a first layer of material comprising:
(1) a first side having a first surface that physically contacts the outer surface of the pump motor, the first surface having a shape that substantially matches the shape of the outer surface of the pump motor; and,
(2) a second side having a second surface that physically contacts a surface of the housing assembly, the second surface having a shape that substantially matches the shape of the surface of the housing assembly.

2. The liftgate assembly of claim 1 wherein the adjustment system is also for use in moving the platform into a storage position.

3. The liftgate assembly of claim 1 wherein the hydraulic pump is also positioned within the housing assembly.

4. The liftgate assembly of claim 1 wherein the housing assembly is substantially enclosed when fully assembled.

5. The liftgate assembly of claim 1 wherein the adjustment system further comprises:
a securing mechanism for use in securing the first layer of material to the hydraulic pump and to the housing assembly.

6. The liftgate assembly of claim 1 wherein:
the first surface of the first side of the first layer of material has a curvilinear shape that substantially matches a curvilinear shape of the outer surface of the pump motor;
the second surface of the second side of the first layer of material has a planar shape that substantially matches a planar shape of the housing assembly.

7. The liftgate assembly of claim 1 wherein:
the housing assembly comprises an inner layer having an inner surface and an outer surface and an outer layer having an inner surface and an outer surface;
the second surface of the first layer of material physically contacts the inner surface of the inner layer of the housing assembly;
the conductive heat transfer system further comprises: a second layer of material comprising:
(1) a first side having a first surface that physically contacts the outer surface of the inner layer of the housing assembly, the first surface having a shape that substantially matches the shape of the outer surface of the inner layer of the housing assembly; and,
(2) a second side having a second surface that physically contacts the inner surface of the outer layer of the housing assembly, the second surface having a shape that substantially matches the shape of the inner surface of the outer layer of the housing assembly.

8. The liftgate assembly of claimed 7 wherein:
the housing assembly comprises a housing shell that defines the outer layer of the housing assembly and a slide tray that defines the inner layer of the housing assembly, wherein the slide tray may be positioned within the housing shell;
the pump and pump motor are positioned on the slide tray;
the first layer of material is positioned between the pump motor and the slide tray; and,
the second layer of material is positioned between the slide tray and the housing shell.

9. The liftgate assembly of claim 1 wherein:
the first surface contacts at least 10% of the outer body surface of the pump motor.

10. The liftgate assembly of claim 1 wherein:
the first surface contacts at least 20% of the outer body surface of the pump motor.

11. The liftgate assembly of claim 1 wherein:
the first surface contacts at least 30% of the outer body surface of the pump motor.

12. The liftgate assembly of claim 1 wherein the pump motor has a length L1 and the first layer of material has a length L2 that is substantially equal to the length L1.

13. The liftgate assembly of claimed 7 wherein the pump motor has a length L1, the first layer of material has a length L2 and the second layer of material has a length L3, wherein the length L2 and the length L3 are each at least as long as the length L1.

14. The liftgate assembly of claimed 13 wherein the first layer of material has a width W2 and the second layer of material has a width W3 that is substantially equal to the width W2.

15. The liftgate assembly of claimed 7 wherein the pump motor has a radius R1, the first layer of material has a width W2 and the second layer of material has a width W3, wherein the width W2 and the width W3 are at least as wide as the radius R1.

16. A method comprising the steps of:
(A) providing a liftgate assembly comprising: a mount assembly for use in mounting the liftgate assembly to an associated vehicle; a platform assembly including a platform having a traffic surface for use in receiving traffic for loading and unloading cargo; a lift arm assembly that interconnects the platform assembly to the mount assembly; an adjustment system for use in moving the platform between a lowered position and a raised position, the adjustment system comprising: (a) at least one hydraulic cylinder; (b) a housing assembly; and, (c) a hydraulic pump and pump motor unit used to provide hydraulic fluid to the first hydraulic cylinder;
(B) providing a first layer of conductive heat transfer material having: (a) a first side with a first surface having a shape that substantially matches the shape of the outer surface of the pump motor; and, (b) a second side with a second surface having a shape that substantially matches the shape of a surface of the housing assembly;
(C) placing the hydraulic pump and pump motor unit and the first layer of conductive heat transfer material within the housing assembly such that the first side contacts the outer surface of the pump motor and the second side contacts the surface of the housing assembly to thereby thermally couple the pump motor to the housing assembly for conductive heat transfer.

17. The method of claim 16 further comprising the step of:
securing the first layer of conductive heat transfer material to the hydraulic pump and to the housing assembly.

18. The method of claim 16 wherein:
step (A) comprises the step of providing the housing assembly with a tray and a housing shell;
step (B) comprises the step of providing the second surface with a shape that substantially matches the shape of an inner surface of the tray;
prior to step (C) the method comprises the step of providing a second layer of conductive heat transfer material having: (a) a first side with a first surface having a shape that substantially matches the shape of the outer surface of the tray; and, (b) a second side with a second surface having a shape that substantially matches the shape of an inner surface of the housing shell;
step (C) comprises the steps of:
placing the first layer of conductive heat transfer material onto the inner surface of the tray;
placing the second layer of conductive heat transfer material onto the outer surface of the tray;
placing the hydraulic pump and motor unit onto the tray such that the pump motor is placed onto the first layer of conductive heat transfer material;
securing the pump motor, the first layer of conductive heat transfer material, the tray, and the second layer of conductive heat transfer material together; and,
sliding the tray into the housing shell.
